(19) United States
(12) Patent Application Publication
(10) Pub. No.: US 2016/0099928 A1
(43) Pub. Date: Apr. 7, 2016

(54) SYSTEMS AND METHODS FOR MANAGING CONNECTIONS FOR UNIVERSAL PLUG-AND-PLAY DEVICES

(71) Applicant: DISH Network L.L.C., Englewood, CO (US)

(72) Inventors: Alistair Chatwin, Englewood, CO (US); Vivek Khemka, Englewood, CO (US)

(21) Appl. No.: 14/875,581

(22) Filed: Oct. 5, 2015

Related U.S. Application Data
(60) Provisional application No. 62/059,728, filed on Oct. 3, 2014.

(51) Int. Cl. H04L 29/06; G06F 17/30

(52) U.S. Cl. CPC H04L 63/08; H04L 65/60; H04L 63/10; G06F 17/30867

(57) ABSTRACT

Systems and methods of managing network connections are disclosed. The method includes receiving a communication from a media device that requests permission to allow a connection between the media device and a client device, processing the communication by querying at least one database with the identifying information for the client device, if a unique identifier for the client device is received from the database, comparing the unique identifier for the client device with a unique identifier for the media device, in the event that the unique identifier for the client device matches the unique identifier for the media device, returning a result to the media device that allows the connection between the media device and the client device, and in the event that the unique identifier for the client device does not match the unique identifier for the media device, returning a result to the media device that does not allow the connection between the media device and the client device.

### CROSS REFERENCE TO RELATED APPLICATIONS

This application claims priority to U.S. provisional application No. 62/059,728 entitled “Bookmarking Data” filed Oct. 3, 2014, the disclosure of which is hereby incorporated by reference in its entirety.

### TECHNICAL FIELD

The technology described herein relates to systems and methods for managing requests for access to a networked media device.

### BACKGROUND

Networked devices that implement Universal Plug and Play (UPnP) or similar communication protocols can potentially discover and connect to any other networked device that also implements UPnP. From a privacy standpoint, this is an undesirable network setup for a hotel or similar establishment because hotel guests could potentially connect to UPnP media devices that are not located in their own rooms. Thus, there is a need for limiting media device connections to at least avoid this undesirable network setup. The information included in this Background section of the specification, including any references cited herein and any description or discussion thereof, is included for technical reference purposes only and is not to be regarded as subject matter by which the scope of the invention as defined in the claims is to be bound.

### SUMMARY

Present embodiments are directed to systems and methods for managing network traffic on a network that includes devices that implement Universal Plug and Play (UPnP) or a similar communication protocol. In one implementation, the disclosed systems and methods include a connection management module that determines if a client device is permitted to connect to a media device based on room assignments within a property in which the network operates.

In a first aspect, the present disclosure is directed to a method of managing network connections, including receiving a communication from a media device that requests permission to allow a connection between the media device and a client device; processing the communication by querying at least one database with the identifying information for the client device; if a unique identifier for the client device is received from the database, comparing the unique identifier for the client device with a unique identifier for the media device; in the event that the unique identifier for the client device matches the unique identifier for the media device, returning a result to the media device that allows the connection between the media device and the client device; and in the event that the unique identifier for the client device does not match the unique identifier for the media device, returning a result to the media device that does not allow the connection between the media device and the client device.

In some implementations, the unique identifier for the client device is a room number assigned to a user of the client device; and the unique identifier for the media device is a room number for a room in which the media device is located.

In some implementations, processing the communication includes querying a connection database with the identifying information for the client device and receiving the room number assigned to the user in return.

In some implementations, the identifying information for the client device and the room number assigned to the user are stored together in the connection database from a prior network authentication for the client device.

In some implementations, processing the communication includes: querying a connection database with the identifying information for the client device and receiving a name of the user in return; and querying a property management database with the name of the user and receiving the room number assigned to the user in return.

In some implementations, the identifying information for the client device and the name of the user are stored together in the connection database from a prior network authentication for the client device; and the name of the user and the room assigned to the user are stored together in the property management database from a prior room check-in procedure for the user.

Some implementations further include returning a result to the media device that does not allow the connection between the media device and the client device in the event that a unique identifier for the client device is not received from the database.

Some implementations further include querying at least one database with the identifying information for the media device and receiving the unique identifier for the media device in return.

In a second aspect, the present disclosure is directed to a method of managing network connections, including: receiving a connection request from a client device at a media device; granting the connection request if a unique identifier for the client device matches a unique identifier for the media device; and denying the connection request if the unique identifier for the client device does not match the unique identifier for the media device or if a unique identifier for the client device cannot be found.

In some implementations, the unique identifier for the client device is a room number assigned to a user of the client device; and the unique identifier for the media device is a room number for a room in which the media device is located.

Some implementations further include, in response to receiving the connection request, transmitting a communication from the media device to a server, the communication including identifying information for the client device and for the media device and including a request for permission to allow the connection between the media device and the client device; receiving a responsive communication from the server; and granting or denying the connection request based on the responsive communication.

In some implementations, the server processes the communication from the media device by querying a connection database with the identifying information for the client device and receiving the room number assigned to the user in return.

In some implementations, the server processes the communication from the media device by querying a connection database with the identifying information for the client device and receiving a name of the user in return, and querying a property management database with the name of the user and receiving the room number assigned to the user in return.

In a third aspect, the present disclosure is directed to a system for managing streaming media connections, including at least one database configured to store client device identifying information in association with unique identifiers for client device users; and a connection management module configured to: receive a communication from a media device that requests permission to allow a connection between the media device and a client device; processes the communication by querying at least one database with the identifying information for the client device; if a unique identifier for the client device is received from the database, compare the unique identifier for the client device with a unique identifier for the media device; in the event that the unique identifier for the client device matches the unique identifier for the media device, return a result to the media device that allows the connection between the media device and the client device; and in the event that the unique identifier for the client device does not match the unique identifier for the media device, return a result to the media device that does not allow the connection between the media device and the client device.

In some implementations, the connection management module is further configured to: receive a network authentication request from the client device; process the network authentication request in the event that the client device provides qualifying network credentials; store the qualifying network credentials in a connection database in association with identifying information for the client device.

In some implementations, the qualifying network credentials include a room number assigned to a user of the client device; the connection module queries at least one database by querying the connection database with the identifying information for the client device and receives the room number assigned to the user in return; and the connection module compares the unique identifier for the client device with a unique identifier for the media device by comparing the room number assigned to the user with a room number assigned to media device.

Some implementations further include a property management module configured to process a room check-in procedure for the user including storing in a property management database a name of the user together with a room number assigned to the user; wherein the qualifying network credentials include a name of the user of the client device; the connection module queries at least one database by querying the property management database with the identifying information for the client device, receiving the name of the user in return, querying the connection database with the name of the user, and receiving the room number assigned to the user in return; and the connection module compares the unique identifier for the client device with a unique identifier for the media device by comparing the room number assigned to the user with a room number assigned to media device.

In some implementations, the connection management module is further configured to return a result to the media device that does not allow the connection between the media device and the client device in the event that a unique identifier for the client device is not received from the database.

In some implementations, the connection management module is further configured to query at least one database with the identifying information for the media device and receive the unique identifier for the media device in return.

In some implementations, the media device is configured to connect to a streaming media source in the event that the connection management module allows the connection between the media device and the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is a schematic of a computer networking environment that includes components and features of present embodiments.

FIG. 2 is a block diagram of an example computer system that includes a server in accordance with present embodiments.

FIG. 3 is a flow chart that illustrates an example method of managing media device connections in accordance with present embodiments.

FIG. 4 is a flow chart that illustrates another example method of managing media device connections in accordance with present embodiments.

FIG. 5 is a flow chart that illustrates an example method of processing a network log-in procedure in accordance with present embodiments.

FIG. 6 is a flow chart that illustrates an example method of processing a guest check-in procedure in accordance with present embodiments.

FIG. 7 is a flow chart that illustrates an example method of processing a connection request at a media device in accordance with present embodiments.

### DETAILED DESCRIPTION

Present embodiments are directed to systems and methods for managing network traffic on a network that includes devices that implement Universal Plug and Play (UPnP) or a similar communication protocol. In one implementation, the disclosed systems and methods include a connection management module that determines if a client device is permitted to connect to a media device based on room assignments within a property in which the network operates. For example, a hotel or similar facility may operate a data network and media devices may be located in the rooms of that facility. The media devices may belong to the hotel or they may be personal property of the hotel guests. In accordance with embodiments disclosed herein, a private communication may occur between the media device and the user's (guest's) device through a third party network, namely the hotel's network. In various implementations, media may be streamed from a streaming media source or directly from the user's laptop or handheld device to the television screen through a media device associated with that particular TV. The connection between the client device and the media device may configured such that other hotel guests do not have access to the media device owned or used by a particular guest.

### System Overview

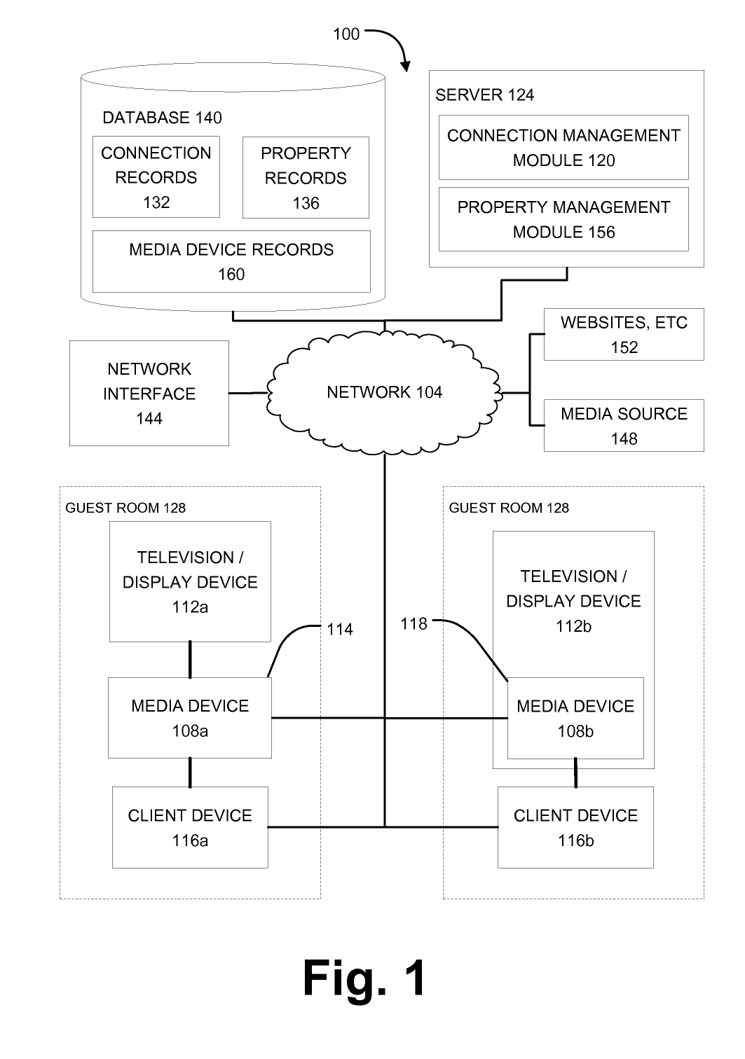

FIG. 1 is a schematic of a computer networking environment 100 that includes components and features of present embodiments. The example networking environment 100 includes a network 104 that is generally configured to support communication among various computers or mobile devices that connect to the network 104. The network 104 may be implemented as a local area network (LAN), a wide area network (WAN), or the like. The network 104 may be generally configured to support wired or wireless connectivity. Devices connected to the network 104 may communicate across the network 104 using an appropriate communication protocol, which in some implementations may be internet protocol (IP). The network 100 may include at least one server 124 and a number of user devices that are configured to be clients of the server 124 or otherwise configured to operate as members of the network 104. The server 124 may be provided in association with one or more databases 140 that store records, user profiles, executable programs, or other data used by the server 124 or the various user devices. The network 104 may additionally include a network interface 144 that provides a mechanism for electronic communication outside of the network 104. The network interface 144 may include a gateway, a modem, or similar device that is configured to facilitate communication between the network 104 and an external network, such as the Internet.

The network 104 is generally configured to support the operation of one or more media devices 108a,b. In one respect, the media devices 108a,b operate as discoverable devices on the network 104. The media devices 108a,b may run a communication protocol such as, Universal Plug and Play (UPnP), that facilities communication among devices that are frequently added and/or removed from the network 104. Using such a protocol, the media devices 108a,b may, in effect, operate as servers on the network 106. In this way, the media devices 108a,b may be discovered by other network devices that are operating as client devices with respect to the media devices 108a,b.

The media devices 108a,b may also operate as streaming media devices. Specifically, the media devices 108a,b may be configured to connect to a streaming media source 148 and to output media received from the streaming media source 148. In another embodiment, media devices 108a,b may permit media to streamed directly from the user's laptop or handheld device. The media devices 108a,b may output the received media to a display device, such as a television 112a,b. As shown in one instance in FIG. 1, a media device 108a may be implemented as a form factor package or dongle 114 that facilitates connection to an open port or connector on the television 112a, which in some implementations may be a High Definition Multimedia Interface (HDMI) port. As shown in another instance in FIG. 1, a media device 108b may also be integrated as a component 118 of the television 112b or other display device. In this implementation, the media device 108b does not connect to the television through an external connector, but rather is a subsystem or component 118 of the television 112b itself.

In operation, a media device 108a,b is discovered by a client device 116a,b, which then uses the media device 108a,b to play streaming media on the television 112a,b or other display device. The client device 116a,b may be a laptop computer, a smart phone, or the like that is capable of running UPnP or a similar communication protocol. Generally, the client device 116a,b may be configured to communicate with various network nodes that may be located on the network 104 or on an external network, such as the Internet. The client device 116a,b may initially be required to authenticate itself to the network 104, for example, by providing payment or by providing network credentials that demonstrate entitlement to use the network 104. Once authenticated, the client device 116a,b may communicate across the network 104, including engaging in network transactions via the network interface 144 with network nodes outside of the network 104. In one example, a properly authenticated client device 116a,b may access an external website 152 via the network connection 144.

The client device 116a,b may connect to the media device 108a,b through an application on the client device 116a,b that executes an appropriate protocol stack so as to communicate over the network 106 as a client of the media device 108a,b. Once connected, the client device 116a,b may issue commands to the media device 108a,b to connect to a particular streaming media source 148 and to output the received media to the television 112a,b. In one implementation, the streaming media source 148 may be associated with the network 104 and accessible only to members of the network 104. By way of example, if the network 104 is associated with a hotel or similar facility, the streaming media source 148 may be provided by the hotel and made available as a service for guests of the hotel. In other implementations, the streaming media source 148 may be associated with a network node on an external network, such as the Internet. Here, the streaming media source may be a commercial service to which a user of the client device 116a,b subscribes through an individual account with the commercial service.

In accordance with embodiments discussed herein, the various media devices 108a,b may communicate across the network 104 via network connections that are managed via a connection management module 120. The connection management module 120 may be generally configured to manage communications among devices on the network 104, including those that are running UPnP or a similar communication protocol. The connection management module 120 may be running on a central server 124 or other such component of the network 104. In one respect, the connection management module 120 may operate to initially authenticate various network devices for communication on the network 104. In one example, the connection management module 120 may receive and process input from a client device 116a,b including payment or network credentials that demonstrate entitlement to use the network 104. Once the client device is properly authenticated, the connection management module 120 may enable the client device 116a,b to communicate on the network 104, including potentially connecting to external network nodes via the network connection 144. The connection management module 120 may also operate to assign the various media devices 108a,b to particular client devices 116a,b. In this way, the connection management module 120 may configure the media devices 108a,b to only accept connections from client devices 116a,b that are specified by the connection management module 120.

In operation, a media device 108a,b may receive a connection request from a client device 116a,b. Prior to granting the request, the media device 108a,b may send a communication to the connection management module 120 that includes identifying information for itself and for the client device 116a,b that is requesting connection. For example, the media device 108a,b may send a communication that includes identifying information, such as a MAC address or an IP address, for both the media device 108a,b and the client device 116a,b attempting to communicate with the media device 108a,b. The connection management module 120 may compare the identifying information for the media device 108a,b and the client device 116a,b to determine if the client device 116a,b is permitted to connect to the media device 108a,b. The connection management module 120 may then return the result of this determination and the media device 108a,b will then allow or not allow the connection, as appropriate.

Generally, the connection management module 120 may operate in a networking environment where connections to various media devices are allowed or not allowed based on the location of the media device with respect to certain designated media areas. In one implementation, the connection management module 120 may determine if the client device 116a,b is permitted to connect to the media device 108a,b based on room assignments within a property in which the network 106 operates. For example, the network 106 may be associated with a hotel or other similar establishment, such as a motel, resort, or the like. The hotel may provide wired and/or wireless network connectivity in various locations throughout the hotel including in guestrooms 128. One or more of the guestroom may include a media device 108a,b. In some instances, each guestroom 128 may be provided with one or more media devices 108a,b associated with one or more televisions 112a,b or other display devices as part of a service provided by the hotel by the hotel or other similar establishment. In other instances, a guestroom may include a media device 108a,b that the property of the guest and that the guest brought with them to the hotel or similar facility. The hotel may wish to limit the people who may connect to a particular media device 108a,b to those guests that are assigned to the guestroom in which the particular media device 108a,b is located. Additionally, the hotel may wish to limit the people who may connect to a particular media device 108a,b so as to prevent hotel guests or others from connecting to media devices 108a,b that do not belong to them. Accordingly, the connection management module 120 may configure a particular media device 108a,b to only allow connections from client devices 116a,b that are associated with guests that are assigned to the guestroom in which the media device 108a,b is located.

The connection management module 120 may determine that a particular connection request is associated with a particular guest based on property management system records of the hotel and/or network connection records for hotel's network 104. When a guest checks into the hotel, the guest will typically connect his or her laptop or mobile device to the hotel network 106. Here, the guest typically logs in using a unique identifier that the hotel understands or specifies. For instance, the guest could log in by providing his or her room number and surname. As a result of this log in process, identifying information for the guest's laptop or mobile device, such as a MAC address or an IP address, may be stored in combination with his or her room number or surname in a connection record database 132. In addition to the connection record database 132, the connection management module 120 may communicate with a property management database 136 that stores guest names in combination with room numbers to which the guests are assigned. When the hotel guest attempts to connect to a media device 108a,b using his or her mobile device as client device 116a,b, the connection management module 120 may allow or deny the connection based on information contained in either the connection record database 132 or the property management database 136.

In accordance with embodiments discussed herein, the property management database 136 may be maintained through the operation of a property management module 156. The property management module 156 may be generally configured to manage guest check-in and check-out procedures to the hotel or other facility in which the network 104 is located. The property management module 156 may be running on the server 124 or other such component of the network 104. Among other functions, the property management module 156 may be configured to intake guest information such as name, home address, telephone number, etc. and to store the information in the property management database 136. As part of the check-in and check-out processing, the property management module 156 may also be configured to update the property management database 136 with current information as to which rooms are occupied by which guests. In this way, the property management module 156 communicates with the property management database 136 so to maintain an updated records of the facility's room numbers stored in combination with information on the guests currently occupying the rooms.

As mentioned, the connection management module 120 may compare identifying information for a media device 108a,b to identifying information for a client device 116a,b to determine if the client device 116a,b is permitted to connect to the media device 108a,b. Here, the connection management module 120 may query the connection record database 132 with identifying information, such as a MAC address or an IP address, that is received from the media device 108a,b and that is associated with the client device 116a,b attempting to connect to the media device 108a,b. Based on a prior logins to the network 106, the connection record database 132 may return a guest name or room number associated with the MAC address or an IP address. In the event that a guest name is returned, the connection management module 120 may additionally query the property management database 136 to obtain a room number for the guest. The connection management module 120 may then compare the room number for the guest making the connection request to a room number for the media device 108a,b receiving the request. If the room numbers match, the connection management module 120 may allow the connection. If the room numbers do not match, the connection management module 120 may deny the connection. In some implementations, media device 108a,b may confirm that it is connecting to an appropriate client device 116a,b by displaying a pop-up or icon on the television 112a,b, which pop-up the guest may select using the television's remote control so as to confirm the connection.

The connection management module 120 may know the room number for the media device 108a,b based on the received identifying information or the connection management module 120 may query a media device records database 160 with the identifying information to discover the room number. In some implementations, the media device 108a,b may belong to the hotel or similar facility in which network operates 104. In these implementations, the hotel or similar facility may record and store identifying information for the media devices 108a,b in combination with the room numbers to which the media devices 108a,b are assigned or otherwise located. The hotel or similar facility may store this information in the media device database 160, which information may then be accessed by the connection management module 120 as the connection management module 120 operates to allow connections to the media devices 108a,b. In other implementations, the media device 108a,b may belong to a guest of the hotel or similar facility in which network operates 104. In these implementations, the hotel or similar facility may discover identifying information for the media device 108a,b through various inputs provided by the owner of the media device 108a,b. Here, the owner may provide identifying information such as a MAC address, IP address or other identifying information as part of a network login or authentication procedure. This identifying information may then be stored in the media device database 160 in combination with a room number in which the guest is staying for the duration of the guest's stay or for a longer time period if needed. Through the media device records database 160, media devices 108a,b information may be accessed by the connection management module 120 as the connection management module 120 operates to allow connections to the media devices. In so doing, the connection management module 120 may operate to allow the owner of a particular media device 108a,b to connect the media device 108a,b using the hotel's network 104 while preventing others from doing the same.

By configuring the various media device 108a,b to only allow connections from client devices 116a,b that are associated with guests that are assigned to the guestroom in which the media device 108a,b is located, the connection management module 120 organizes network 106 traffic in a more efficient and effective manner. Without the functionality provided by the connection management module 120, network devices running UPnP or a similar communication protocol could discover and connect to any media device 108a,b on the network 106. From a privacy standpoint, this is an undesirable network setup for a hotel or similar establishment because hotel guests could potentially connect to and play media on televisions 112a,b that are not in their own rooms. By limiting media device 108a,b connections as described herein, the operation of the connection management module 120 avoids this undesirable network setup. Additionally, by limiting media device 108a,b connections as described herein, the operation of the connection management module 120 may reduce the overall usage of network 106 resources. In this way, the operation of the connection management module 120 may free up network 106 resources for other operations and, in so doing, increase the efficiency of the network 106.

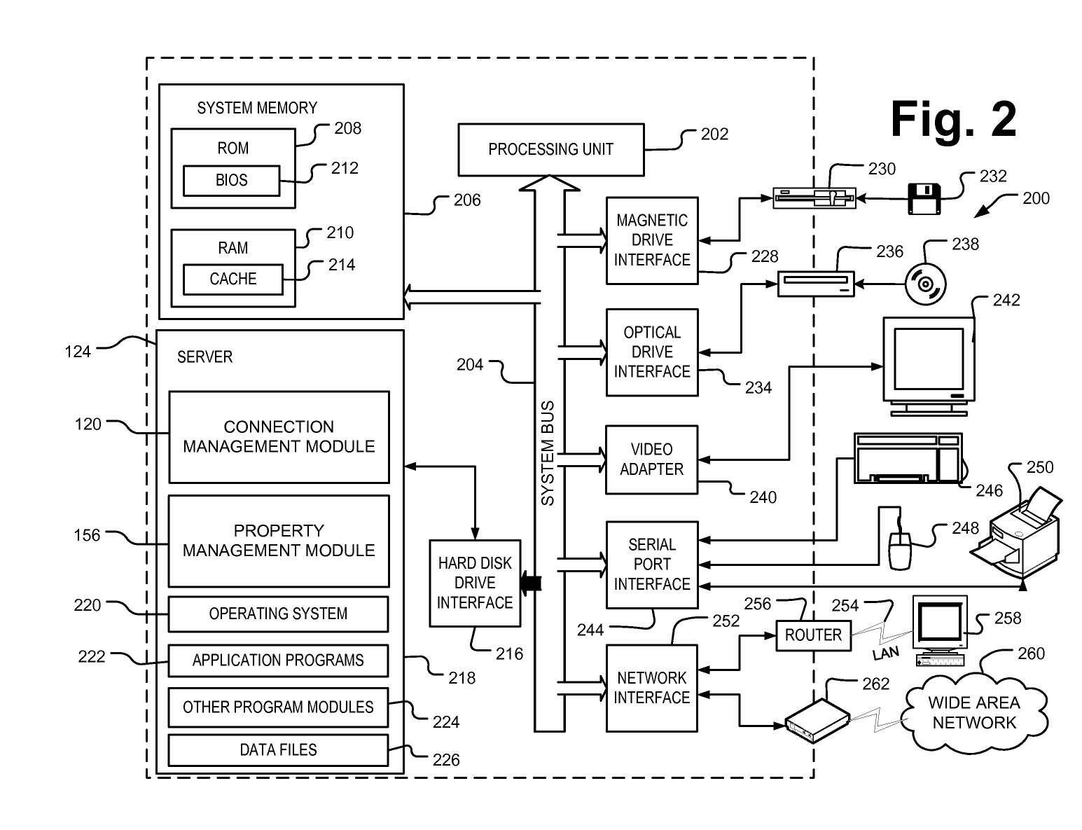

For at least one embodiment, a computer system 200 for implementing the connection management module 120 and/or the property management module 156 is depicted in FIG. 2. The computer system 200 used to implement the connection management module 120 and/or the property management module 156 may be a computing device such as a single-server, clustered server, blade server, or virtual server operating environment, or possibly a personal computer (PC), a mainframe computer, a distributed computer, an Internet appliance, or other computer devices, or combinations thereof, with internal processing and memory components as well as interface components for connection with external input, output, storage, network, and other types of peripheral devices. Internal components of the computer system in FIG. 2 are shown within the dashed line and external components are shown outside of the dashed line. Components that may be internal or external are shown straddling the dashed line.

In any embodiment or component of the system described herein, the computer system 200 includes a processor 202 and a system memory 206 connected by a system bus 204 that also operatively couples various system components. There may be one or more processors 202, e.g., a single central processing unit (CPU), or a plurality of processing units, commonly referred to as a parallel processing environment (for example, a dual-core, quad-core, or other multi-core processing device). The system bus 204 may be any of several types of bus structures including a memory bus or memory controller, a peripheral bus, a switched fabric, point to point connection, and a local bus using any of a variety of bus architectures. The system memory 206 includes read only memory (ROM) 208 and random access memory (RAM) 210. A basic input/output system (BIOS) 212, operating system kernel or the like, containing the basic routines that help to transfer information between elements within the computer system 200, such as during start up, may be stored in ROM 208 or otherwise provided. A cache 214 may be set aside in RAM 210 to provide a high speed memory store for frequently accessed data.

A hard disk drive interface 216 may be connected with the system bus 204 to provide read and write access to a data storage device, e.g., a hard disk drive 218, for nonvolatile storage of applications, files, and data. Other types of non-volatile memory and/or storage devices may be utilized including but not limited to internal and external solid state storage drives. A number of program modules and other data may be stored on the hard disk 218, including an operating system 220, one or more application programs 222, and data files 224. In an exemplary implementation, the hard disk drive 218 may store code associated with the connection management module 120 and/or the property management module 156 according to the exemplary processes described herein. Note that the hard disk drive 218 may be either an internal component or an external component of the computer system 200 as indicated by the hard disk drive 218 straddling the dashed line in FIG. 2. In some configurations, there may be both an internal and an external hard disk drive 218.

The computer system 200 may further include a magnetic disk drive 230 for reading from or writing to a removable magnetic disk 232, tape, or other magnetic media. The magnetic disk drive 230 may be connected with the system bus 204 via a magnetic drive interface 228 to provide read and write access to the magnetic disk drive 230 initiated by other components or applications within the computer system 200. The magnetic disk drive 230 and the associated computer readable media may be used to provide nonvolatile storage of computer readable instructions, data structures, program modules, and other data for the computer system 200.

The computer system 200 may additionally include an optical disk drive 236 for reading from or writing to a removable optical disk 238 such as a CD ROM or other optical media. The optical disk drive 236 may be connected with the system bus 204 via an optical drive interface 234 to provide read and write access to the optical disk drive 236 initiated by other components or applications within the computer system 200. The optical disk drive 236 and the associated computer readable optical media may be used to provide nonvolatile storage of computer readable instructions, data structures, program modules, and other data for the computer system 200.

A display device 242, e.g., a monitor, a television, or a projector, or other type of presentation device may also be connected, directly or indirectly, to the system bus 204 via an interface, such as a video adapter/interface 240. Similarly, audio devices, for example, external speakers or a microphone (not shown), may be connected directly or indirectly to the system bus 204 through an audio interface (not shown).

In addition to the monitor 242, the computer system 200 may include other peripheral input and output devices, which are often connected to the processor 202 and memory 206 through the serial port interface 244 that is coupled to the system bus 204. Input and output devices may also or alternately be connected with the system bus 204 by other interfaces, for example, a universal serial bus (USB), an IEEE 1394 interface (“Firewire”), a parallel port, or a game port. A user may enter commands and information into the computer system 200 through various input devices including, for example, a keyboard 246 and pointing device 248, for example, a mouse. Other input devices (not shown) may include, for example, a joystick, a game pad, a tablet, a touch screen device, a satellite dish, a scanner, a facsimile machine, a microphone, a digital camera, and a digital video camera.

Output devices may include, for example, a printer 250, a plotter, a photocopier, a photo printer, a facsimile machine, and a press. In some implementations, several of these input and output devices may be combined into single devices, for example, a printer/scanner/fax/photocopier. It should also be appreciated that other types of computer readable media and associated drives for storing data, for example, magnetic cassettes or flash memory drives, may be accessed by the computer system 200 via the serial port interface 244 (e.g., USB) or similar port interface.

The computer system 200 may operate in a networked environment using logical connections through a network interface 252 coupled with the system bus 204 to communicate with one or more remote devices. The logical connections depicted in FIG. 2 include a local area network (LAN) 254 and a wide area network (WAN) 260. Such networking environments are commonplace in home networks, office networks, enterprise wide computer networks, and intranets. These logical connections may be achieved by a communication device coupled to or integral with the computer system 200. As depicted in FIG. 2, the LAN 254 may use a router 256 or hub, wired or wireless, internal or external, to connect with remote devices, e.g., a remote computer 258, similarly connected on the LAN 254. The remote computer 258 may be another personal computer, a server, a client, a peer device, or other common network node, and typically includes many or all of the elements described above relative to the computer system 200.

To connect with a WAN 260, the computer system 200 typically includes a modem 262 for establishing communications over the WAN 260. Typically the WAN 260 may be the Internet. However, in some instances the WAN 260 may be a large private network spread among multiple locations, or a virtual private network (VPN). The modem 262 may be a telephone modem, a high speed modem (e.g., a digital subscriber line (DSL) modem), a cable modem, or similar type of communications device. The modem 262, which may be internal or external, is connected to the system bus 204 via the network interface 252. In alternate embodiments the modem 262 may be connected via the serial port interface 244. It should be appreciated that the network connections shown are exemplary and other means of and communications devices for establishing a network communications link between the computer system 200 and other devices or networks may be used.

### Connection Management Module Operations

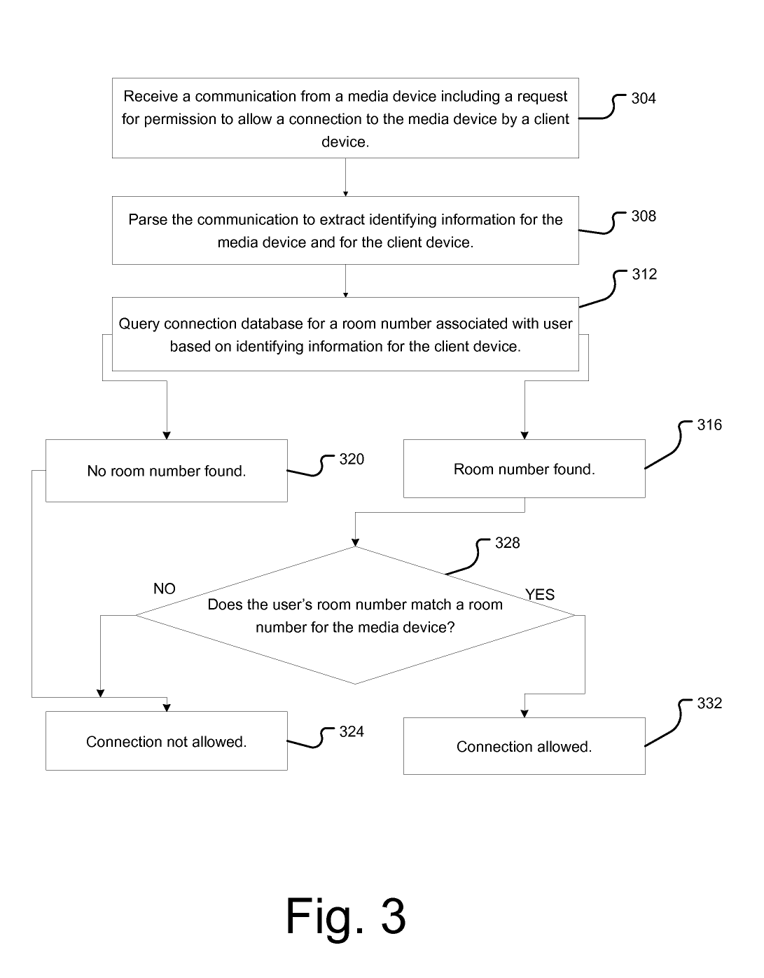

FIG. 3 is a flow chart 300 that illustrates an example method of managing media device connections in accordance with present embodiments. The method illustrated by flow chart 300 includes operations that may be executed by the connection management module 120 illustrated in FIG. 1. As mentioned, the connection management module 120 may be generally configured to manage the connection between client devices and media devices that are associated with various media areas within a facility. By way of example, FIG. 3 illustrates operations of a connection management module 120 that is implemented in the context of a hotel or similar facility where various media devices are associated with guestrooms in the hotel. By way of further example, FIG. 3 illustrates operations of a connection management module 120 where hotel guests log into the hotel's computer network by providing a room to which they are assigned for their stay at the hotel.

Initially, in operation 304, the connection management module 120 operating on the server 124 may receive a communication from a media device 108a,b. The communication may request permission to allow a connection to the media device 108a,b, where the connection is requested by a client device 116a,b. The communication may include information that identifies the various devices involved in the potential connection. In accordance with various embodiments, the communication may include identifying information, such as a MAC address or an IP address, for the media device 108a,b and for the client device 116a,b that is the requesting connection.

In operation 308, the connection management module 120 may parse the communication received from the media device to extract the device identifying information. The connection management module 120 extracts this identifying information for use in discovering unique identifiers for the media device and the client device. More specifically, the connection management module 120 extracts the identifying information for use in discovering a room number assigned to the user and a room number associated with the media device.

In operation 312, the connection management module 120 queries the connection database 132 for a unique identifier associated with the client device 116a,b. Here, the connection management module 120 sends a transmission that includes a MAC address, IP address or other identifying information for the client device 116a,b obtained in operation 308. In the event that the connection database 132 has a record for the client device 116a,b, the connection database 132 returns the appropriate unique identifier in operation 316. In this case, the unique identifier is the room number assigned to the user associated with the client device 116a,b. As mentioned, the identifying information for the client device 116a,b and the room number assigned to the user are stored together in the connection database 132 from a prior network authentication for the client device 116a,b. In the event that the connection database 132 does not have a record for the client device 116a,b, the connection database 132 returns a negative result in operation 320.

In the event that the connection database 132 returns a negative result to the connection management module 120, operation 324 is executed following operation 320. In operation 324, the connection management module 120 returns a result to the media device 108a,b that denies the media device 108a,b permission to connect to the client device. In the event that the connection database 132 returns a client device unique identifier to the connection management module 120, operation 328 is executed following operation 316.

In operation 328, the connection management module 120 compares the unique identifier for the client device with a unique identifier associated with the media device 108a,b. In this case, the connection management module 120 compares the room number assigned to the user of the client device 116a,b with the room number in which the media device is located. If the comparison made in operation 328 indicates that the room numbers match, the connection management module 120 may indicate to the media device 108a,b that the connection is allowed in operation 332. In response, the media device 108a,b may allow the connection request from the client device 116a,b. If the comparison made in operation 328 indicate that the room numbers do not match, the connection management module 120 may indicates to the media device 108a,b that the connection is not allowed in operation 324. In response, the media device 108a,b may deny the connection request from the client device 116a,b.

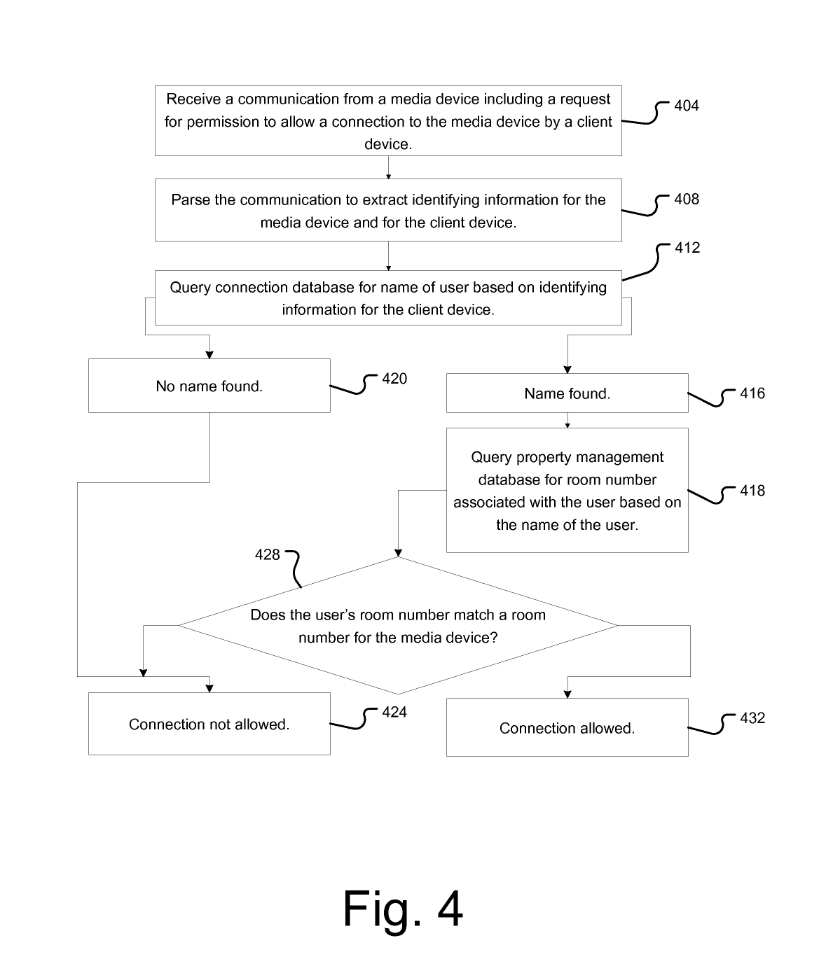

FIG. 4 is a flow chart 400 that illustrates another example method of managing media device connections in accordance with present embodiments. The method illustrated by flow chart 400 includes operations that may be executed by the connection management module 120 illustrated in FIG. 1. As mentioned, the connection management module 120 may be generally configured to manage connection between client devices and media devices that are associated with various media areas within a facility. By way of example, FIG. 4 illustrates operations of a connection management module 120 that is implemented in the context of a hotel or similar facility where various media devices are associated with guestrooms in the hotel. By way of further example, FIG. 4 illustrates operations of a connection management module 120 where hotel guests log into the hotel's computer network by providing their name.

Initially, in operation 404, the connection management module 120 operating on the server 124 may receive a communication from a media device 108a,b. The communication may request permission to allow a connection to the media device 108a,b, where the connection is requested by a client device 116a,b. The communication may include information that identifies the various devices involved in the potential connection. In accordance with various embodiments, the communication may include identifying information, such as a MAC address or an IP address, for the media device 108a,b and for the client device 116a,b that is the requesting connection.

In operation 408, the connection management module 120 may parse the communication received from the media device to extract the device identifying information. The connection management module 120 extracts this identifying information for use in discovering unique identifiers for the media device and the client device. More specifically, the connection management module 120 extracts the identifying information for use in discovering a room number assigned to the user and a room number associated with the media device.

In operation 412, the connection management module 120 queries the connection database 132 for a name of the user associated with the client device 116a,b. Here, the connection management module 120 sends a transmission that includes a MAC address, IP address or other identifying information for the client device 116a,b obtained in operation 408. In the event that the connection database 132 has a record for the client device 116a,b, the connection database 132 returns the appropriate name in operation 416. As mentioned, the identifying information for the client device 116a,b and the name of the user associated with the client device 116a,b are stored together in the connection database 132 from a prior network authentication for the client device 116a,b. In the event that the connection database 132 does not have a record for the client device 116a,b, the connection database 132 returns a negative result in operation 420.

In the event that the connection database 132 returns a negative result to the connection management module 120, operation 424 is executed following operation 420. In operation 424, the connection management module 120 returns a result to the media device 108a,b that denies the media device 108a,b permission to connect to the client device. In the event that the connection database 132 returns the name of the user associated with the client device 116a,b to the connection management module 120, operation 418 is executed following operation 416.

In operation 418, the connection management module 120 queries the property management database 136 for a unique identifier associated with the client device 116a,b. Here, the connection management module 120 sends a transmission that includes the name of the user associated with the client device 116a,b obtained in operation 416. In this case, the unique identifier is the room number assigned to the user associated with the client device 116a,b. As mentioned, the name of the user associated with the client device 116a,b and the room number assigned to the user are stored together in the property management database 136 from guest check-in procedure executed for the user who, in the case, is a hotel guest. Following operation 418, the connection management module 120 may execute operation 428.

In operation 428, the connection management module 120 compares the unique identifier for the client device with a unique identifier associated with the media device 108a,b. In this case, the connection management module 120 compares the room number assigned to the user of the client device 116a,b with the room number in which the media device is located. If the comparison made in operation 428 indicates that the room numbers match, the connection management module 120 may indicate to the media device 108a,b that the connection is allowed in operation 432. In response, the media device 108a,b may allow the connection request from the client device 116a,b. If the comparison made in operation 428 indicates that the room numbers do not match, the connection management module 120 may indicate to the media device 108a,b that the connection is not allowed in operation 424. In response, the media device 108a,b may deny the connection request from the client device 116a,b.

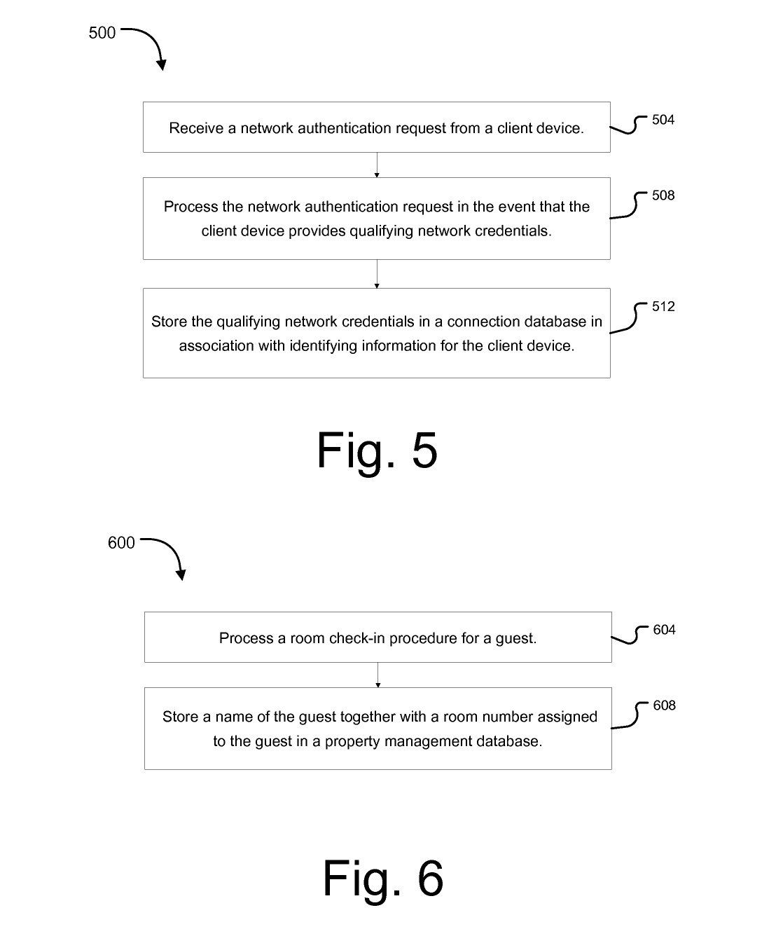

FIG. 5 is a flow chart 500 that illustrates an example method of processing a network log-in procedure in accordance with present embodiments. The method illustrated by flow chart 500 includes operations that may be executed by the connection management module 120 illustrated in FIG. 1. As mentioned, the connection management module 120 be configured to process initial login procedures, as well as being to manage connection between client devices and media devices.

Initially, in operation 504, the connection management module 120 receives a network authentication request from a client device. The network authentication may be a log-in that is initiated by a hotel guest. Here, the hotel guest may be connecting to the hotel network 106 using his or her laptop, mobile device, or the like. In logging onto the network 106, the hotel guest may provide a unique identifier that the hotel understands or specifies such as his or her room number and surname. In operation 508, the connection management module 120 processes the network authentication request in the event that the client device provides qualifying network credentials. In operation 512, the connection management module 120 stores the qualifying network credentials in a connection database in association with identifying information for the client device. In one example, the connection management module 120 stores identifying information for the client device in combination with identifying information for the guest's laptop or mobile device, such as a MAC address or an IP address, in the connection record database 132. The connection management module 120 or other module executing on the server 124 may then query the connection record database 132 at a later time to retrieve the stored information as part of processing a media device 108a,b connection request.

In some implementations, the connection management module 120 may be configured to discover identifying information for a media device 108a,b belonging to a guest of the hotel or similar facility in which network operates 104. Here, the guest may provide various identifying information such as a MAC address, IP address or other identifying information as part of a network login or authentication procedure. The connection management module 120 may store this identifying information in the media device database 160 in combination with a room number in which the guest is staying for the duration of the guest's stay or for a longer time period if needed. Through the media device records database 160, media devices 108a,b information may be accessed by the connection management module 120 as the connection management module 120 operates to allow connections to the media devices 108a,b. In so doing, the connection management module 120 may operate to allow the owner of a particular media device 108a,b to connect the media device 108a,b using the hotel's network 104 while preventing others from doing the same.

### Property Management Module Operations

FIG. 6 is a flow chart 600 that illustrates an example method of processing a guest check-in procedure in accordance with present embodiments. The method illustrated by flow chart 600 includes operations that may be executed by the property management module 156 illustrated in FIG. 1. As mentioned, the property management module 156 may be configured to process check-in procedures in a hotel or similar facility. Initially, in operation 604, the property management module 156 processes a room check-in procedure for a guest. In operation 608, the property management module 156 stores a name of the guest together with a room number assigned to the guest in a property management database 136. The connection management module 120 or other module executing on the server 124 may then query the property management database 136 at a later time to retrieve the stored information as part of processing a media device 108a,b connection request.

### Media Device Operations

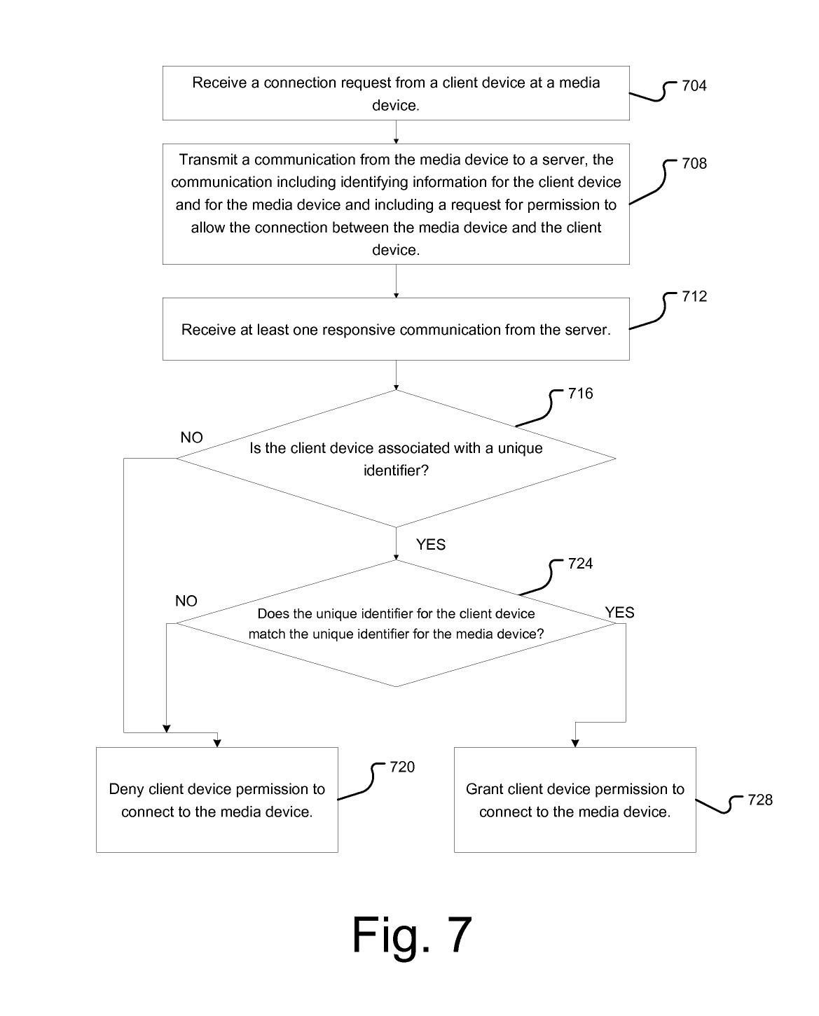

FIG. 7 is a flow chart 700 that illustrates an example method of processing a connection request at a media device in accordance with present embodiments. The method illustrated by flow chart 700 includes operations that may be executed by the media device 108a,b illustrated in FIG. 1. As mentioned, the connection management module 120 may operate as a discoverable streaming media device that may be configured to connect to a streaming media source 148 and to output media received from the streaming media source 148.

Initially, in operation 704, the media device 108a,b receives a connection request from a client device 116a,b. Here, the media device 108a,b may be operating as a discoverable device on a network 104 that is generally configured to connect to a streaming media source 148 and to play streaming media received form the source on a television or other display device 112a,b. Operating as an authenticated device on the network 104, the client device 116a,b may discover the media device 108a,b and request a connection.

In operation 708, the media device 108a,b transmits a communication from the media device to a server. The communication sent by the media device 108a,b may include identifying information for the client device and for the media device. For example, the media device 108a,b may send a communication that includes identifying information, such as a MAC address or an IP address, for both the media device 108a,b and the client device 116a,b attempting to communicate with the media device 108a,b. The communication sent by the media device 108a,b may additionally include a request for permission to allow the connection between the media device and the client device.

In operation 712, the media device 108a,b receives at least one responsive communication from the server. In one implementation, the responsive communication includes a unique identifier for both the client device 116a,b and the media device 108a,b. In one implementation, the media device 108a,b is aware of its own unique identifier through data stored locally at the media device 108a,b. In this case, the responsive communication received from the server may only include a unique identifier for the client device 116a,b. In implementations where the media device is operating in a hotel or similar facility, the unique identifier for the client device may be a room number assigned to a user of the client device and the unique identifier for the media device may be a room number for a room in which the media device is located.

In operation 716, the media device 108a,b determines if the client device 116a,b is associated with a unique identifier. It may be the case that the communication received from the server returns a negative result indicating that the server cannot locate a unique identifier for the client device 116a,b. This may occur, for example, if someone who is not a guest of the hotel attempts to connect to the media device 108a,b. Thus, as a first step in processing the communication received from the server, the media device 108a,b may determine if any unique identifier is received from the server. If no unique identifier is returned by the server, the media device 108a,b denies client device permission to connect to the media device in operation 720. If a unique identifier is returned by the server, operation 724 is executed following operation 716.

In operation 724, the media device 108a,b determines if the unique identifier for the client device matches the unique identifier for the media device. For example, in implementations where the media device is operating in a hotel or similar facility and the unique identifiers correspond to room numbers, the media device 108a,b compares the room assigned to the user of the client device to the room number of the room in which the media device is located. If the room numbers do not match, the media device 108a,b denies the client device permission to connect to the media device in operation 720. If the room numbers match, the media device 108a,b grants the client device permission to connect to the media device in operation 728. If the connection is allowed, the client device 116a,b may use the media device 108a,b to streaming media content as desired by the user of the client device 116a,b. In this way, a private communication may occur between the media device 108a,b and the user's (guest's) device 116a,b through a third party network, which may be the hotel's network. Using this connection, media may be streamed from a streaming media source in accordance with one embodiment. In another embodiment, media may be streamed directly from the user's laptop or handheld device to a television screen through a media device associated with that particular TV. The connection between the client device 116a,b and the media device 108a,b may configured such that other hotel guests do not have access to the media device owned or used by a particular guest.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the invention. One implementation of a computer program product provides a non-transitory computer program storage medium readable by a computer system and encoding a computer program. It should further be understood that the described technology may be employed in special purpose devices independent of a personal computer.

The above specification, examples and data provide a description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method of managing network connections, comprising:
receiving a communication from a media device that requests permission to allow a connection between the media device and a client device;
processing the communication by querying at least one database with the identifying information for the client device;
if a unique identifier for the client device is received from the database, comparing the unique identifier for the client device with a unique identifier for the media device;
in the event that the unique identifier for the client device matches the unique identifier for the media device, returning a result to the media device that allows the connection between the media device and the client device; and
in the event that the unique identifier for the client device does not match the unique identifier for the media device, returning a result to the media device that does not allow the connection between the media device and the client device.

2. The method of claim 1, wherein:
the unique identifier for the client device is a room number assigned to a user of the client device; and
the unique identifier for the media device is a room number for a room in which the media device is located.

3. The method of claim 1, wherein processing the communication comprises querying a connection database with the identifying information for the client device and receiving the room number assigned to the user in return.

4. The method of claim 3, wherein the identifying information for the client device and the room number assigned to the user are stored together in the connection database from a prior network authentication for the client device.

5. The method of claim 1, wherein processing the communication comprises:
querying a connection database with the identifying information for the client device and receiving a name of the user in return; and
querying a property management database with the name of the user and receiving the room number assigned to the user in return.

6. The method of claim 5, wherein:
the identifying information for the client device and the name of the user are stored together in the connection database from a prior network authentication for the client device; and
the name of the user and the room assigned to the user are stored together in the property management database from a prior room check-in procedure for the user.

7. A method of claim 1, further comprising returning a result to the media device that does not allow the connection between the media device and the client device in the event that a unique identifier for the client device is not received from the database.

8. A method of claim 1, further comprising querying at least one database with the identifying information for the media device and receiving the unique identifier for the media device in return.

9. A method of managing network connections, comprising:
receiving a connection request from a client device at a media device;
granting the connection request if a unique identifier for the client device matches a unique identifier for the media device; and
denying the connection request if the unique identifier for the client device does not match the unique identifier for the media device or if a unique identifier for the client device cannot be found.

10. The method of claim 9, wherein:
the unique identifier for the client device is a room number assigned to a user of the client device; and
the unique identifier for the media device is a room number for a room in which the media device is located.

11. The method of claim 10, further comprising:
in response to receiving the connection request, transmitting a communication from the media device to a server, the communication including identifying information for the client device and for the media device and including a request for permission to allow the connection between the media device and the client device;
receiving a responsive communication from the server; and
granting or denying the connection request based on the responsive communication.

12. The method of claim 11, wherein the server processes the communication from the media device by querying a connection database with the identifying information for the client device and receiving the room number assigned to the user in return.

13. The method of claim 11, wherein the server processes the communication from the media device by querying a connection database with the identifying information for the client device and receiving a name of the user in return, and querying a property management database with the name of the user and receiving the room number assigned to the user in return.

14. A system for managing streaming media connections, comprising
at least one database configured to store client device identifying information in association with unique identifiers for client device users; and
a connection management module configured to:
receive a communication from a media device that requests permission to allow a connection between the media device and a client device;
processes the communication by querying at least one database with the identifying information for the client device;
if a unique identifier for the client device is received from the database, compare the unique identifier for the client device with a unique identifier for the media device;
in the event that the unique identifier for the client device matches the unique identifier for the media device, return a result to the media device that allows the connection between the media device and the client device; and
in the event that the unique identifier for the client device does not match the unique identifier for the media device, return a result to the media device that does not allow the connection between the media device and the client device.

15. The system of claim 14, wherein the connection management module is further configured to:
receive a network authentication request from the client device;
process the network authentication request in the event that the client device provides qualifying network credentials;
store the qualifying network credentials in a connection database in association with identifying information for the client device.

16. The system of claim 15, wherein:
the qualifying network credentials include a room number assigned to a user of the client device;
the connection module queries at least one database by querying the connection database with the identifying information for the client device and receives the room number assigned to the user in return; and
the connection module compares the unique identifier for the client device with a unique identifier for the media device by comparing the room number assigned to the user with a room number assigned to media device.

17. The system of claim 15, further comprising:
a property management module configured to process a room check-in procedure for the user including storing in a property management database a name of the user together with a room number assigned to the user; wherein
the qualifying network credentials include a name of the user of the client device;
the connection module queries at least one database by querying the property management database with the identifying information for the client device, receiving the name of the user in return, querying the connection database with the name of the user, and receiving the room number assigned to the user in return; and
the connection module compares the unique identifier for the client device with a unique identifier for the media device by comparing the room number assigned to the user with a room number assigned to media device.

18. The system of claim 14, wherein the connection management module is further configured to return a result to the media device that does not allow the connection between the media device and the client device in the event that a unique identifier for the client device is not received from the database.

19. The system of claim 14, wherein the connection management module is further configured to query at least one database with the identifying information for the media device and receive the unique identifier for the media device in return.

20. The system of claim 14, wherein the media device is configured to connect to a streaming media source in the event that that the connection management module allows the connection between the media device and the client device.
